(19) United States
(12) Patent Application Publication
(10) Pub. No.: US 2025/0203631 A1
(43) Pub. Date: Jun. 19, 2025

(54) METHODS AND APPARATUSES FOR ONE-SHOT SIDELINK HARQ-ACK FEEDBACK TRANSMISSION

(71) Applicant: LENOVO (BEIJING) LIMITED, BEIJING (CN)

(72) Inventors: HAIPENG LEI, BEIJING (CN); XIAODONG YU, BEIJING (CN); ZHENNIAN SUN, BEIJING (CN); XIN GUO, BEIJING (CN)

(21) Appl. No.: 18/833,905

(22) PCT Filed: Jan. 28, 2022
(86) PCT No.: PCT/CN2022/074652

§ 371 Date: Jul. 28, 2024

(51) Int. Cl. H04W 72/25; H04L 1/1607; H04L 1/1812; H04L 5/00

(52) U.S. Cl. CPC H04W 72/25; H04L 1/1614; H04L 1/1819; H04L 5/0044; H04L 5/0055

(57) ABSTRACT

The present application relates to methods and apparatuses for one-shot sidelink hybrid automatic repeat request acknowledgement (HARQ-ACK) feedback transmission. One embodiment of the present disclosure provides a user equipment (UE), which includes: a processor; and a transceiver coupled to the processor, wherein the processor is configured to cause the UE to: receive, via the transceiver, a sidelink control information (SCI) format including a first indicator requesting transmission of hybrid automatic repeat request acknowledgement (HARQ-ACK) feedback for a plurality of physical sidelink shared channels (PSSCH), wherein each of the plurality of PSSCHs has an associated HARQ process number; and transmit, via the transceiver, requested HARQ-ACK feedback for the plurality of PSSCHs.

### TECHNICAL FIELD

The present disclosure relates to wireless communication technology, and more particularly to methods and apparatuses for one-shot sidelink hybrid automatic repeat request acknowledgement (HARQ-ACK) feedback transmission.

### BACKGROUND OF THE INVENTION

For sidelink transmission, the sidelink control information (SCI) is transmitted on physical sidelink control channel (PSCCH) which includes information for associated PSSCH scheduling. The SCI and associated PSSCH may be transmitted from a transmit (Tx) UE to a specific receive (Rx) UE in unicast manner, to a group of Rx UEs in groupcast manner, or to any other UEs within a range in broadcast manner. The PSSCH may carry data which requires corresponding HARQ-ACK feedback from the Rx UE(s) to the Tx UE.

For sidelink transmission on unlicensed spectrum, if channel access procedure (i.e. listen before talk (LBT)) is successful, the Tx UE transmits a PSSCH to the Rx UE and waits for the reception of PSFCH from the Rx UE.

Before transmitting the sidelink HARQ-ACK feedback to the Tx UE, the Rx UE may need to perform LBT. If the LBT at Rx UE side is failed, the sidelink HARQ-ACK feedback may not be transmitted, and the Tx UE has to retransmit the PSSCH even when the Rx UE has correctly decoded the PSSCH.

If LBT at Rx UE side is successful, the Rx UE transmits PSFCH to Tx UE. Due to hidden node interference on the shared unlicensed spectrum, the Tx UE may not correctly decode the PSFCH. In this case, the Tx UE also has to retransmit the PSSCH even when the Rx UE has correctly decoded the PSSCH.

Therefore, solutions for reporting sidelink HARQ-ACK feedback are desirable.

### SUMMARY

One embodiment of the present disclosure provides a user equipment (UE), which may include: a processor; and a transceiver coupled to the processor, wherein the transceiver is configured to: receive a sidelink control information (SCI) format including a first indicator requesting transmission of hybrid automatic repeat request acknowledgement (HARQ-ACK) feedback for a plurality of physical sidelink shared channels (PSSCH), wherein each of the plurality of PSSCHs has an associated HARQ process number; and transmit requested HARQ-ACK feedback for the plurality of PSSCHs.

In some embodiments, the plurality of PSSCHs comprise PSSCHs associated with all HARQ processes of the UE.

In some embodiments, the SCI format further includes a second indicator for indicating the plurality of PSSCHs, where at least one of: the second indicator indicates HARQ process number of each of the plurality of PSSCHs; the second indicator comprises a bitmap with each bit corresponding to a HARQ process number associated with one PSSCH of the plurality of PSSCHs; the second indicator comprises a bitmap with each bit corresponding to a respective HARQ process number group, and each respective HARQ process number group includes one or more consecutive HARQ process numbers associated with one or more PSSCHs of the plurality of PSSCHs; or a number of consecutive HARQ process numbers and the first HARQ process number of the consecutive HARQ process numbers are jointly indicated by the second indicator.

In some embodiments, the SCI format schedules a PSSCH and further indicates an associated HARQ process number of the scheduled PSSCH, and the second indicator indicates a number of consecutive HARQ process numbers associated with a same number of PSSCHs of the plurality of PSSCHs, wherein the first HARQ process number of the number of consecutive HARQ process numbers is the HARQ process number of the scheduled PSSCH.

In some embodiments, the requested HARQ-ACK feedback for the plurality of PSSCHs is transmitted on a plurality of PSFCHs with each of the plurality of PSFCHs carrying HARQ-ACK feedback corresponding to one PSSCH of the plurality of PSSCHs, and the processor is further configured to: determine a resource index of a first PSFCH for a first PSSCH and the resource indices of the plurality of PSFCHs, wherein the first PSSCH is scheduled by the SCI format and the resource indices of the plurality of PSFCHs contiguously follow the resource index of the first PSFCH; determine a resource index of each PSFCH of the plurality of PSFCHs based on the HARQ process number associated with the corresponding PSSCH of the plurality of PSSCHs; or determine a resource index of each PSFCH of the plurality of PSFCHs from a dedicated PSFCH resource pool.

In some embodiments, the requested HARQ-ACK feedback for the plurality of PSSCHs is transmitted on one PSSCH and a resource of the PSSCH is reserved by the SCI format.

In some embodiments, the requested HARQ-ACK feedback for the plurality of PSSCHs is included in one HARQ-ACK codebook and transmitted on one PSFCH.

In some embodiments, in response to a total number of the plurality of PSFCHs being larger than a maximum number of transmitted PSFCHs in one slot by the UE, the processor is further configured to: bundle every multiple HARQ-ACK information bits of the requested HARQ-ACK feedback into one HARQ-ACK bit, wherein a bundle size is determined by the total number of the plurality of PSFCHs and the maximum number of transmitted PSFCHs in one slot by the UE, and wherein the transceiver is configured to transmit the maximum number of PSFCHs in one slot with each PSFCH carrying one bundled HARQ-ACK bit: or divide the plurality of PSFCHs into multiple groups with each group comprising a number of PSFCHs not larger than the maximum number of transmitted PSFCHs in one slot by the UE, wherein the transceiver is configured to transmit the HARQ-ACK feedback of the multiple groups in multiple slots with each group transmitted in one slot.

Another embodiment of the present disclosure provides an apparatus, which may include: a processor; and a transceiver coupled to the processor, wherein the transceiver is configured to: transmit, to a user equipment (UE), a sidelink control information (SCI) format including a first indicator requesting the UE to transmit hybrid automatic repeat request acknowledgement (HARQ-ACK) feedback for a plurality of physical sidelink shared channels (PSSCH), wherein each of the plurality of PSSCHs has an associated HARQ process number; and receive, from the UE, requested HARQ-ACK feedback for the plurality of PSSCHs.

In some embodiments, the plurality of PSSCHs comprise PSSCHs associated with all HARQ processes of the UE.

In some embodiments, SCI format further includes a second indicator for indicating the plurality of PSSCHs, wherein at least one of: the second indicator indicates HARQ process number of each of the plurality of PSSCHs: the second indicator comprises a bitmap with each bit corresponding to a HARQ process number associated with one PSSCH of the plurality of PSSCHs: the second indicator comprises a bitmap with each bit corresponding to a respective HARQ process number group, and each respective HARQ process number group includes one or more consecutive HARQ process numbers associated with one or more PSSCHs of the plurality of PSSCHs: or a number of consecutive HARQ process numbers and the first HARQ process number of the consecutive HARQ process numbers are jointly indicated by the second indicator.

In some embodiments, the SCI format schedules a PSSCH and further indicates an associated HARQ process number of the scheduled PSSCH, and the second indicator indicates a number of consecutive HARQ process numbers associated with a same number of PSSCHs of the plurality of PSSCHs, wherein the first HARQ process number of the number of consecutive HARQ process numbers is the HARQ process number of the scheduled PSSCH.

In some embodiments, the requested HARQ-ACK feedback for the plurality of PSSCHs is received on a plurality of PSFCHs with each of the plurality of PSFCHs carrying HARQ-ACK feedback corresponding to one PSSCH of the plurality of PSSCHs, and the processor is further configured to: determine a resource index of a first PSFCH for a first PSSCH and the resource indices of the plurality of PSFCHs, wherein the first PSSCH is scheduled by the SCI format and the resource indices of the plurality of PSFCHs contiguously follow the resource index of the first PSFCH; determine a resource index of each PSFCH of the plurality of PSFCHs based on the HARQ process number associated with the corresponding PSSCH of the plurality of PSSCHs; or determine a resource index of each PSFCH of the plurality of PSFCHs from a dedicated PSFCH resource pool.

In some embodiments, the requested HARQ-ACK feedback for the plurality of PSSCHs is received on one PSSCH and a resource of the PSSCH is reserved by the SCI format.

In some embodiments, the requested HARQ-ACK feedback for the plurality of PSSCHs is included in one HARQ-ACK codebook and received on one PSFCH.

In some embodiments, in response to a total number of the plurality of PSFCHs being larger than a maximum number of transmitted PSFCHs in one slot by the UE, wherein the transceiver is configured to: receive the maximum number of PSFCHs in one slot with each PSFCH carrying one bundled HARQ-ACK bit: or receive the HARQ-ACK feedback of the multiple groups in multiple slots with each group transmitted in one slot.

Yet another embodiment of the present disclosure provides a method performed by a user equipment (UE), which may include: receiving a sidelink control information (SCI) format including a first indicator requesting transmission of hybrid automatic repeat request acknowledgement (HARQ-ACK) feedback for a plurality of physical sidelink shared channels (PSSCH), wherein each of the plurality of PSSCHs has an associated HARQ process number; and transmitting requested HARQ-ACK feedback for the plurality of PSSCHs.

In some embodiments, the plurality of PSSCHs comprise PSSCHs associated with all HARQ processes of the UE.

In some embodiments, the SCI format further includes a second indicator for indicating the plurality of PSSCHs, wherein at least one of: the second indicator indicates HARQ process number of each of the plurality of PSSCHs; the second indicator comprises a bitmap with each bit corresponding to a HARQ process number associated with one PSSCH of the plurality of PSSCHs; the second indicator comprises a bitmap with each bit corresponding to a respective HARQ process number group, and each respective HARQ process number group includes one or more consecutive HARQ process numbers associated with one or more PSSCHs of the plurality of PSSCHs; or a number of consecutive HARQ process numbers and the first HARQ process number of the consecutive HARQ process numbers are jointly indicated by the second indicator.

In some embodiments, the SCI format schedules a PSSCH and further indicates an associated HARQ process number of the scheduled PSSCH, and the second indicator indicates a number of consecutive HARQ process numbers associated with a same number of PSSCHs of the plurality of PSSCHs, wherein the first HARQ process number of the number of consecutive HARQ process numbers is the HARQ process number of the scheduled PSSCH.

In some embodiments, the requested HARQ-ACK feedback for the plurality of PSSCHs is transmitted on a plurality of PSFCHs with each of the plurality of PSFCHs carrying HARQ-ACK feedback corresponding to one PSSCH of the plurality of PSSCHs, and the method further includes: determining a resource index of a first PSFCH for a first PSSCH and the resource indices of the plurality of PSFCHs, wherein the first PSSCH is scheduled by the SCI format and the resource indices of the plurality of PSFCHs contiguously follow the resource index of the first PSFCH; determining a resource index of each PSFCH of the plurality of PSFCHs based on the HARQ process number associated with the corresponding PSSCH of the plurality of PSSCHs; or determining a resource index of each PSFCH of the plurality of PSFCHs from a dedicated PSFCH resource pool.

In some embodiments, the requested HARQ-ACK feedback for the plurality of PSSCHs is transmitted on one PSSCH and a resource of the PSSCH is reserved by the SCI format.

In some embodiments, the requested HARQ-ACK feedback for the plurality of PSSCHs is included in one HARQ-ACK codebook and transmitted on one PSFCH.

In some embodiments, in response to a total number of the plurality of PSFCHs being larger than a maximum number of transmitted PSFCHs in one slot by the UE, and wherein the method further includes: bundling every multiple HARQ-ACK information bits of the requested HARQ-ACK feedback into one HARQ-ACK bit, wherein a bundle size is determined by the total number of the plurality of PSFCHs and the maximum number of transmitted PSFCHs in one slot by the UE; and transmitting the maximum number of PSFCHs in one slot with each PSFCH carrying one bundled HARQ-ACK bit: or dividing the plurality of PSFCHs into multiple groups with each group comprising a number of PSFCHs not larger than the maximum number of transmitted PSFCHs in one slot by the UE; and transmitting the HARQ-ACK feedback of the multiple groups in multiple slots with each group transmitted in one slot.

Still another embodiment of the present disclosure provides a method, which may include: transmitting, to a user equipment (UE), a sidelink control information (SCI) format including a first indicator requesting the UE to transmit hybrid automatic repeat request acknowledgement (HARQ-ACK) feedback for a plurality of physical sidelink shared channels (PSSCH), wherein each of the plurality of PSSCHs has an associated HARQ process number; and receiving, from the UE, requested HARQ-ACK feedback for the plurality of PSSCHs.

In some embodiments, the plurality of PSSCHs comprise PSSCHs associated with all HARQ processes of the UE.

In some embodiments, the SCI format further includes a second indicator for indicating the plurality of PSSCHs, and the second indicator indicates HARQ process number of each of the plurality of PSSCHs: the second indicator comprises a bitmap with each bit corresponding to a HARQ process number associated with one PSSCH of the plurality of PSSCHs: the second indicator comprises a bitmap with each bit corresponding to a respective HARQ process number group, and each respective HARQ process number group includes one or more consecutive HARQ process numbers associated with one or more PSSCHs of the plurality of PSSCHs; or a number of consecutive HARQ process numbers and the first HARQ process number of the consecutive HARQ process numbers are jointly indicated by the second indicator.

In some embodiments, the SCI format schedules a PSSCH and further indicates an associated HARQ process number of the scheduled PSSCH, and the second indicator indicates a number of consecutive HARQ process numbers associated with a same number of PSSCHs of the plurality of PSSCHs, wherein the first HARQ process number of the number of consecutive HARQ process numbers is the HARQ process number of the scheduled PSSCH.

In some embodiments, the requested HARQ-ACK feedback for the plurality of PSSCHs is received on a plurality of PSFCHs with each of the plurality of PSFCHs carrying HARQ-ACK feedback corresponding to one PSSCH of the plurality of PSSCHs, and wherein the method further includes: determining a resource index of a first PSFCH for a first PSSCH and the resource indices of the plurality of PSFCHs, wherein the first PSSCH is scheduled by the SCI format and the resource indices of the plurality of PSFCHs contiguously follow the resource index of the first PSFCH; determining a resource index of each PSFCH of the plurality of PSFCHs based on the HARQ process number associated with the corresponding PSSCH of the plurality of PSSCHs; or determining a resource index of each PSFCH of the plurality of PSFCHs from a dedicated PSFCH resource pool.

In some embodiments, the requested HARQ-ACK feedback for the plurality of PSSCHs is received on one PSSCH and a resource of the PSSCH is reserved by the SCI format.

In some embodiments, the requested HARQ-ACK feedback for the plurality of PSSCHs is included in one HARQ-ACK codebook and received on one PSFCH.

In some embodiments, in response to a total number of the plurality of PSFCHs being larger than a maximum number of transmitted PSFCHs in one slot by the UE, and wherein the method further includes: receiving the maximum number of PSFCHs in one slot with each PSFCH carrying one bundled HARQ-ACK bit: or receiving the HARQ-ACK feedback of the multiple groups in multiple slots with each group transmitted in one slot.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary wireless communication system (e.g., a sidelink communication system) according to some embodiments of the present disclosure.

FIG. 2 illustrates an exemplary sidelink HARQ-ACK feedback transmission according to some embodiments of the present disclosure.

FIG. 3 illustrates an exemplary sidelink HARQ-ACK feedback transmission according to some embodiments of the present disclosure.

FIG. 4 illustrates an exemplary sidelink HARQ-ACK feedback transmission according to some embodiments of the present disclosure.

FIG. 5A illustrates a method performed by a UE for wireless communication according to some embodiments of the present disclosure.

FIG. 5B illustrates a method performed by an apparatus for wireless communication according to some embodiments of the present disclosure.

FIG. 6 illustrates a block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results: sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

Embodiments of the present disclosure may be provided in a network architecture that adopts various service scenarios, for example but not limited to, 3GPP 3G, LTE, LTE-Advanced (LTE-A), 3GPP 4G, 3GPP 5G NR, 3GPP Release 16 and onwards, etc. It is contemplated that along with the 3GPP and related communication technology development, the terminologies recited in the present disclosure may change, which should not affect the principle of the present disclosure.

User equipment (UE) under NR sidelink scenario and/or LTE sidelink scenario may be referred to as sidelink UE(s). A sidelink UE which transmits data on sidelink may be referred to as a UE for transmitting, a transmitting UE, a transmitting sidelink UE, a Tx UE, a sidelink Tx UE, a sidelink (SL) Tx UE, or the like. A sidelink UE which receives data on sidelink may be referred to as a UE for receiving, a receiving UE, a receiving sidelink UE, an Rx UE, a sidelink Rx UE, an SL Rx UE, or the like.

Sidelink UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like.

According to some embodiments of the present disclosure, sidelink UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present disclosure, sidelink UE(s) may include wearable devices, such as smart watches, fitness bands, optical head-mounted displays, or the like. Moreover, sidelink UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. Sidelink UE(s) may communicate directly with BS(s) via communication signals.

A BS under NR sidelink scenario and/or LTE sidelink scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME), a serving gateway (SGW), and/or a packet data network gateway (PGW).

A BS may serve a number of sidelink UEs within a serving area, for example, a cell or a cell sector via a wireless communication link. A BS may communicate directly with one or more sidelink UEs via communication signals. For example, a BS may serve sidelink UEs within a macro cell.

Sidelink communication between a Tx UE and an Rx UE under NR sidelink scenario includes groupcast communication, unicast communication, or broadcast communication.

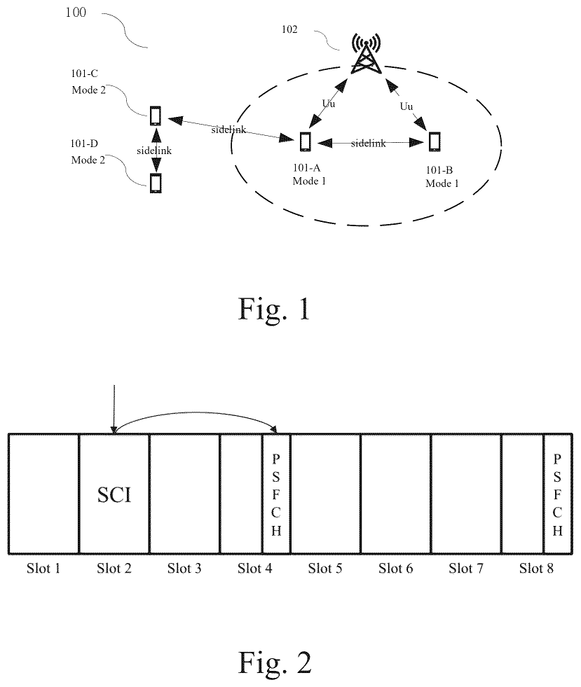

FIG. 1 illustrates an exemplary wireless communication system (e.g., a sidelink communication system) according to some embodiments of the present disclosure.

As shown in FIG. 1, the sidelink communication system 100 includes a base station, i.e., BS 102, and some sidelink UEs, i.e., UE 101-A, UE 101-B, UE 101-C, and UE 101-D. UE 101-A and UE 101-B are within the coverage of the BS 102, and UE 101-C and UE 101-D are outside the coverage of the BS 102. UE 101-A, UE 101-B, UE 101-C, and UE 101-D may perform sidelink unicast transmission, sidelink groupcast transmission, or sidelink broadcast transmission. It is contemplated that, in accordance with some other embodiments of the present disclosure, a sidelink communication system may include more BSs and more or fewer sidelink UEs.

In addition, although the sidelink UE as shown in FIG. 1 is illustrated in the shape of a cellphone, it is contemplated that a sidelink communication system may include any type of UE (e.g., a roadmap device, a cell phone, a computer, a laptop, IoT device or other type of device) in accordance with some other embodiments of the present disclosure.

According to some embodiments of FIG. 1, UE 101-A may function as a Tx UE, and UE 101-B, UE 101-C, and UE 101-D may function as Rx UEs. UE 101-A may exchange sidelink messages with UE 101-B or UE 101-C through a sidelink using the NR technology, or the LTE technology, through PC5 interface as defined in 3GPP documents. UE 101-A may transmit information or data to other UE(s) within the sidelink communication system through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Alternatively, according to some other embodiments of FIG. 1, UE 101-B or UE 101-C may function as a Tx UE and transmit sidelink messages, and UE 101-A may function as an Rx UE and receive the sidelink messages from UE 101-B or UE 101-C.

Both UE 101-A and UE 101-B in the embodiments of FIG. 1 may transmit information to the BS 102 and receive control information from the BS 102, for example, via NR Uu interface. The BS 102 may define one or more cells, and each cell may have a coverage area. As shown in FIG. 1, both UE 101-A and UE 101-B are within the coverage of the BS 102, while UE 101-C and UE 101-D are not.

The BS 102 as illustrated and shown in FIG. 1 is not a specific base station, but may be any base station(s) in the sidelink communication system. For example, if the sidelink communication system includes two BSs 102, UE 101-A being within a coverage area of any one the two BSs 102 may be called as a case that UE 101-A is within a coverage of BS 102 in the sidelink communication system; and only UE 101-A being outside of coverage area(s) of both BSs 102 can be called as a case that UE 101-A is outside of the coverage of BS 102 in the sidelink communication system.

Although NR sidelink was initially developed for sidelink applications, there is growing interest in the industry to expand the applicability of NR sidelink to commercial use cases. For commercial sidelink applications, two key requirements have been identified:
Increased sidelink data rate; and
Support of new carrier frequencies for sidelink.

Increased sidelink data rate is motivated by applications such as sensor information (video) sharing between vehicles with high degree of driving automation. Commercial use cases could require data rates in excess of what is possible in Rel-17. Increased data rate can be achieved with the support of sidelink carrier aggregation and sidelink over unlicensed spectrum. Furthermore, by enhancing the frequency range 2 (FR2) sidelink operation, increased data rate can be more efficiently supported on FR2.

While the support of new carrier frequencies and larger bandwidths would also improve its data rate, the main benefit would come from making sidelink more applicable for a wider range of applications. More specifically, with the support of unlicensed spectrum and the enhancement in FR2, sidelink will be in a better position to be implemented in commercial devices since utilization of the intelligent transport system (ITS) band is limited to ITS safety related applications.

The present disclosure proposes some solutions for requesting one-shot sidelink HARQ-ACK feedback reporting as follows:

### Solution 1:

In solution 1, a new SCI format is introduced for requesting the sidelink HARQ-ACK feedback. Specifically, the first UE (i.e. the Tx UE) may transmit the SCI format to the second UE (i.e. the Rx UE), to request the second UE to transmit the sidelink HARQ-ACK feedback to the first UE. The SCI format may also schedule a PSSCH, and indicate the associated HARQ process number of the scheduled PSSCH. The sidelink HARQ-ACK feedback at least correspond to a plurality of PSSCHs, and may also correspond to the scheduled PSSCH depending on different solutions.

In particular, a first indicator, which may be referred to as a HARQ-ACK feedback request indicator, is included in the SCI format for requesting the HARQ-ACK feedback for the plurality of PSSCHs. The first indicator may be included in the 1^{st} stage SCI format, or in the 2^{nd} stage SCI format, and the size of the indicator may be one bit. Hereinafter in the present disclosure, this indicator may be referred to as the first indicator.

In one embodiment, the value “1” of the bit of the first indicator requests HARQ-ACK feedback corresponding to both the plurality of PSSCHs and the scheduled PSSCH, while the value “0” of the bit requests HARQ-ACK feedback corresponding to the scheduled PSSCH only, or vice versa.

In another embodiment, the value “1” of the bit of the first indicator requests HARQ-ACK feedback corresponding to both the plurality of PSSCHs and the scheduled PSSCH while the value “0” of the bit does not request any HARQ-ACK feedback, or vice versa.

In some cases, the plurality of PSSCHs may include all the sidelink HARQ processes. If the HARQ-ACK feedback request indicator is enabled, i.e. the value of the bit of the first indicator is set to “1”, the second UE may transmit HARQ-ACK feedback for all the sidelink HARQ processes. Therefore, the first indicator, which may only include one single bit, can request sidelink HARQ-ACK reporting for all the sidelink HARQ processes.

In some other cases, the SCI format may further include another indicator for indicating the plurality of PSSCHs. Hereinafter in the present disclosure this indicator is referred to as the second indicator. The second indicator may be included either in the 1^{st} stage SCI format, or in the 2^{nd} stage SCI format, and the size of the second indicator varies according to the specific options for indicating the plurality of PSSCHs. The options may include (options 1-1, 1-2, 1-3, 1-4, and 1-5):

### Option 1-1

The second indicator indicates the HARQ process number of each of the plurality of PSSCHs.

Indicating one HARQ process number may require 4 bits, thus the SCI format may be used to request HARQ-ACK feedback associated with a limited number of PSSCHs, and the total number of PSSCHs may depend on the available bits in the SCI format.

For example, if the plurality of PSSCHs includes 2 PSSCHs, and the two PSSCHs may be requested by the SCI format for transmitting (or retransmitting) the corresponding sidelink HARQ-ACK feedback, therefore, 8 bits may be required in the SCI format, for indicating the HARQ process number of the two PSSCHs. These HARQ process numbers may be included either in the 1^{st} stage SCI format, or in the 2^{nd} stage SCI format.

In this option, in addition to the HARQ process number associated with a PSSCH scheduled by the SCI format, the SCI format also indicates the HARQ process number associated with each of the plurality of PSSCHs.

### Option 1-2

The second indicator may be a bitmap, and each bit in the bitmap corresponds to one HARQ process number. Each PSSCH of the plurality of PSSCHs has an associated HARQ process number. Via the bitmap, the plurality of PSSCHs can be indicated by the associated HARQ process numbers.

There may be maximum 16 sidelink HARQ process numbers, in some embodiments, the bitmap may include 15 bits with each bit corresponding to one HARQ process number, and the HARQ process number of the scheduled PSSCH is not indicated by the bitmap.

For example, assuming sidelink HARQ-ACK feedback is requested by setting the bit value to “1”, and the bitmap is “000001111100000” suggests that the sidelink HARQ-ACK feedback for the 6th to the 10th HARQ processes is requested while the others are not requested. Hence, the plurality of PSSCHs comprises 5 PSSCHs with associated HARQ process numbers from 5 to 9, wherein HARQ process number of 0 is assumed as the first HARQ process of the 16 processes.

In some other embodiments, the bitmap may include 16 bits, and each bit corresponds to one HARQ process number of both the scheduled PSSCH and the plurality of PSSCHs. In this case, the HARQ process number of the scheduled PSSCH may be indicated twice, and the second UE may transmit one PSFCH carrying the HARQ-ACK feedback for the scheduled PSSCH.

Therefore, in option 1-2, the maximum number of sidelink HARQ processes that may be requested is 16, and the maximum size of the bitmap may be configured as 16.

### Option 1-3

In option 1-3, the second indicator may be a bitmap. Different from option 1-2, each bit in the bitmap corresponds to a group of HARQ processes. Each HARQ process group may include multiple consecutive HARQ process numbers, and each HARQ process group may include the same (or different) number of HARQ process numbers. The plurality of PSSCHs is indicated by the one or more groups of HARQ process numbers with one HARQ process number associated with one of the plurality of PSSCHs.

For example, there are 16 sidelink HARQ process numbers, and they are divided into 4 HARQ process groups with each HARQ process group including 4 consecutive HARQ process numbers. In other words, every 4 consecutive HARQ process numbers are included in one HARQ process group. For example, the first group may include HARQ process number from 0 to 3, the second group may include HARQ process number from 4 to 7, the third group may include HARQ process number from 8 to 11, and the fourth group may include HARQ process number from 12 to 15.

Assuming sidelink HARQ-ACK feedback is requested by setting the bit value to “1”, and the bitmap is “0011” suggests that the sidelink HARQ-ACK feedback for the third and fourth HARQ process groups is requested, while the others are not requested. In this way, sidelink HARQ-ACK feedback for those PSSCHs with HARQ process numbers from 8 to 15 are requested.

For another example, the 16 sidelink HARQ process numbers may be divided into other number of HARQ process groups, such as 2, 3, 8, etc. It should be noted that for some numbers such as 3, the HARQ process groups may include different numbers of HARQ process numbers.

To sum up, the SCI format further includes the second indicator, with each bit corresponding to one HARQ process group. In this way, the second indicator in option 1-3 may request sidelink HARQ-ACK feedback for maximum 16 sidelink HARQ processes with fewer bits compared to option 1-2.

### Option 1-4

The second indicator may include a number of bits, which indicate the total number of consecutive HARQ process numbers. The starting HARQ process number of the consecutive HARQ process numbers is the HARQ process number associated with the PSSCH scheduled by the SCI format, which is already indicated by the SCI format.

There are maximum 16 sidelink HARQ process numbers, thus maximum 4 bits are sufficient and included in the SCI format for indicating the number of consecutive HARQ process numbers.

For example, the bits value of the second indicator may indicate the total number of consecutive HARQ process numbers according to the following table 2:

TABLE 2

| | the total number of consecutive |
|---|---|
| bits of the second indicator | HARQ process numbers |
| 0000 | 1 |
| 0001 | 2 |
| 0010 | 3 |
| 0011 | 4 |
| 0100 | 5 |
| 0101 | 6 |
| 0110 | 7 |
| 0111 | 8 |
| 1000 | 9 |
| 1001 | 10 |
| 1010 | 11 |
| 1011 | 12 |
| 1100 | 13 |
| 1101 | 14 |
| 1110 | 15 |
| 1111 | 16 |

According to table 2, in the second row, the bits of the second indicator are “0000”, which indicates the total number of consecutive HARQ process numbers is 1. Since a single HARQ process is requested, thus the sidelink HARQ-ACK feedback for the HARQ process number associated with the PSSCH scheduled by the SCI format is requested. For another example, in the third row, the bits of the second indicator are “0001”, which indicates the total number of consecutive HARQ process numbers is 2, therefore, besides the HARQ process for the scheduled PSSCH, an additional HARQ process which is next to the HARQ process for the scheduled PSSCH is indicated. So the sidelink HARQ-ACK feedback for the two consecutive HARQ process numbers is requested. In the last row, the bits of the second indicator are “1111”, which indicates the total number of consecutive HARQ process numbers is 16, therefore, the sidelink HARQ-ACK feedback for the 16 consecutive HARQ process numbers, i.e., all the HARQ process numbers, is requested.

It should be noted that the corresponding relationship (between the bits of the second indicator and the total number of consecutive HARQ process numbers) in table 2 is exemplary, not limiting, and other mapping may also be defined.

### Option 1-5

The second indicator may include a number of bits, which indicate both the total number of consecutive HARQ process numbers and the starting HARQ process number of these consecutive HARQ process numbers.

There are maximum 16 sidelink HARQ process numbers, thus maximum 8 bits are sufficient and included in the SCI format for indicating both the total number of consecutive HARQ process numbers and the first HARQ process number of these consecutive HARQ process numbers via resource indication value (RIV).

In particular: in the case that the starting HARQ process number is 1, the total number of consecutive HARQ process numbers may range from 1 to 16; in the case that the starting HARQ process number is 2, the total number of consecutive HARQ process numbers may range from 1 to 15: in the case that the starting HARQ process number is 3, the total number of consecutive HARQ process numbers may range from 1 to 14; . . . , in the case that the starting HARQ process number is 16, the total number of consecutive HARQ process numbers may be 1. Therefore, the total number of all the possible combinations of the starting HARQ process number and the total number of consecutive HARQ process numbers is: 16+15+14+13+12+11+10+9+8+7+6+5+4+3+2+1=136, thus maximum 8 bits are required to indicate all possible combinations.

For example, the second indicator may indicate both the first HARQ process number and the number of consecutive HARQ process numbers according to the following table 3:

TABLE 3

| | | the total number of |
|---|---|---|
| bits of the second | the starting HARQ | consecutive HARQ |
| indicator | process number | process numbers |
| 00000000 | 1 | 1 |
| 00000001 | 1 | 2 |
| 00000010 | 1 | 3 |
| 00000011 | 1 | 4 |
| . . . | . . . | . . . |
| 00001000 | 2 | 1 |
| 00001001 | 2 | 2 |
| . . . | . . . | . . . |

According to table 3, in the first row, the bits of the second indicator are “0000000”, which indicates the starting HARQ process number in the total number of consecutive HARQ process numbers is the 1st HARQ process number in the total number of consecutive HARQ process numbers, and the total number of consecutive HARQ process numbers is 1. Accordingly, the sidelink HARQ-ACK feedback for the first HARQ process number in the total number of consecutive HARQ process numbers is requested.

In the 7^{th} row, the bits of the second indicator are “00001001”, which indicates the starting HARQ process number in the total number of consecutive HARQ process numbers is the 2^{nd} HARQ process number in the total number of consecutive HARQ process numbers, and the total number of consecutive HARQ process numbers is 2. Accordingly, the sidelink HARQ-ACK feedback for the 2^{nd} and the 3^{rd} HARQ process number in the total number of consecutive HARQ process numbers is requested.

It should be noted that the corresponding relationship (among the bits of the second indicator, the starting HARQ process number, and the total number of consecutive HARQ process numbers) in table 3 is exemplary, not limiting, and other mapping may also be defined.

At the second UE side, the second UE determines the resource(s) for transmitting the requested sidelink HARQ-ACK feedback for the plurality of PSSCHs.

In one embodiment, the requested sidelink HARQ-ACK feedback for the plurality of PSSCHs is transmitted on one PSSCH. The PSSCH may be reserved by the first UE via the new SCI format.

Specifically, the SCI format reserves a PSSCH, the second UE transmits the PSSCH to the first UE, and the HARQ-ACK information bits for the plurality of PSSCHs are carried in the PSSCH. For example, the HARQ-ACK information bits may be in the form of a bitmap in MAC CE with each bit of the bitmap corresponding to one of the plurality of PSSCHs.

In some other embodiments, the requested sidelink HARQ-ACK feedback for the plurality of PSSCHs is transmitted on a plurality of PSFCHs with each of the plurality of PSFCHs carrying HARQ-ACK feedback corresponding to one PSSCH of the plurality of PSSCHs.

At the second UE side, regarding PSFCH resource for transmitting the requested sidelink HARQ-ACK feedback for the plurality of PSSCHs, upon reception of the SCI format in slot n, the second UE may transmit the sidelink HARQ-ACK feedback for the plurality of PSSCHs in the first slot that includes PSFCH resources and is X slots offset to slot n, where X is configured by the RRC parameter, which may be referred to as: MinTimeGapPSFCH.

The present disclosure proposes several options for determining PSFCH resource(s) as follows (option 1-a, 1-b, 1-c, and 1-d):

### Option 1-a

The second UE first determines an index of a PSFCH resource for a PSSCH scheduled by the SCI format, specifically, the index of the PSFCH resource, which may be referred to as Z, is calculated as follows:

$$Z = ( {P}_{ID} + {M}_{ID} ) mod {R}_{PRB , CS}^{PSFCH}$$

where
P_{ID} is a physical layer source ID provided by the SCI format;
M_{ID} is the identity of the UE receiving the PSSCH as indicated by higher layers if the UE detects a SCI format indicating groupcast with ACK or NACK based HARQ-ACK feedback (i.e., cast type indicator field value of “01”); otherwise, M_{ID} is zero; and
R_{PRB, CS}^{PSFCH} is the total number of PSFCH resources available for a PSFCH transmission.

The second UE then determines the indices of the corresponding PSFCH resources for transmitting the requested sidelink HARQ-ACK feedback for the plurality of PSSCHs. Specifically, the indices of the PSFCH resources are determined based on the index of the PSFCH resource, Z.

For example, the plurality of PSSCHs may be ordered by their associated HARQ process numbers, for example, in the ascending order of the associated HARQ process numbers, or the descending order of the associated HARQ process numbers, or the like. The index of each PSFCH for each PSSCH of the plurality of PSSCHs may follow the index Z.

For example, the total number of the plurality of PSSCHs is N, therefore, the indices of the corresponding PSFCH resources for the plurality of PSSCHs may be Z+1, Z+2, . . . , Z+N.

### Option 1-b

In this option, the second UE determines the index of a PSFCH resource for each of the plurality of PSSCHs separately, specifically, the index of a PSFCH resource for each PSSCH is as follows:

$$( {P}_{ID} + {M}_{ID} + i ) mod {R}_{PRB , CS}^{PSFCH}$$

where
P_{ID} is a physical layer source ID provided by the SCI format;
M_{ID} is the identity of the UE receiving the PSSCH as indicated by higher layers if the UE detects a SCI format indicating groupcast with ACK or NACK based HARQ-ACK feedback (i.e., cast type indicator field value of “01”); otherwise, M_{ID} is zero;
i is the sidelink HARQ process number corresponding to the PSSCH; and
R_{PRB, CS}^{PSFCH} is the total number of PSFCH resources available for a PSFCH transmission.

### Option 1-c

In this option, in addition to the PSFCH resource pool for the scheduled PSSCH, the present disclosure proposes a dedicated PSFCH resource pool, which is configured for the requested sidelink HARQ-ACK feedback transmission for the plurality of PSSCHs.

The second UE determines the PSFCH resources for the requested sidelink HARQ-ACK feedback transmission for the plurality of PSSCHs from the dedicated PSFCH resource pool.

### Option 1-d

In option 1-d, similar to option 1-a, the second UE determines the index of the PSFCH resource, Z, as follows:

$$( {P}_{ID} + {M}_{ID} ) mod {R}_{PRB , CS}^{PSFCH}$$

The second UE further determines one HARQ-ACK codebook, which includes the HARQ-ACK information bits for the plurality of PSSCHs, and the HARQ-ACK codebook is transmitted in the PSFCH resource with the index Z. This is possible since interlace-based PSFCH is to be adopted which can provide abundant resources for large payload PSFCH format.

Correspondingly, the first UE also determines the PSFCH resource(s) for receiving the requested sidelink HARQ-ACK feedback for the plurality of PSSCHs and the scheduled PSSCH in a similar fashion as the second UE does.

### Solution 2

In solution 2, the first UE may transmit the SCI format to the second UE, to request the second UE to transmit the sidelink HARQ-ACK feedback. Different from solution 1, the SCI format does not schedule a PSSCH, and correspondingly does not indicate the associated HARQ process number of the scheduled PSSCH, either. The sidelink HARQ-ACK feedback only corresponds to a plurality of PSSCHs.

The first indication, i.e., a HARQ-ACK feedback request indicator, is included in the SCI format for requesting the HARQ-ACK feedback for the plurality of PSSCHs. Specifically, the value “1” of the bit of the first indicator may request HARQ-ACK feedback corresponding to the plurality of PSSCHs; and the value “0” of the bit does not request any HARQ-ACK feedback, or vice versa. The first indicator may be included in the 1^{st} stage SCI format.

In some cases, the plurality of PSSCHs may include all the sidelink HARQ process numbers. If the HARQ-ACK feedback request indicator is enabled, i.e., the value of the bit of the first indicator is set to “1”, the second UE shall transmit HARQ-ACK feedback for all the sidelink HARQ process numbers. Therefore, the indicator, which may only include one single bit, can request sidelink HARQ-ACK reporting for all the sidelink HARQ processes.

In some other cases, the SCI format may further include another indicator for indicating the plurality of PSSCHs. Hereinafter in the present disclosure, this indicator is referred to as the second indicator. The second indicator may be included either in the 1^{st} stage SCI format or in the 2^{nd} stage SCI format.

The resource reservation related fields in the SCI format may be used as the second indicator to indicate the plurality of PSSCHs. For example, resource reservation period may be used to indicate the group of PSSCHs.

In solution 2, the SCI format does not schedule a PSSCH, thus the PSSCH scheduling related fields may be used as the second indicator to indicate the plurality of PSSCHs. For example, frequency resource assignment field, time resource assignment field, demodulation reference signal (DMRS) pattern, Beta_offset indicator, number of DMRS port, modulation coding scheme (MCS), additional MCS table indicator, PSFCH overhead indicator, or any combinations thereof, may be used to indicate the group of PSSCHs.

The size of the second indicator varies according to the specific option for indicating the plurality of PSSCHs. The options may include (options 2-1, 2-2, and 2-3):

### Option 2-1

Option 2-1 is similar to option 1-2, in particular, the second indicator may be a bitmap, and each bit in the bitmap corresponds to one HARQ process number. Each PSSCH of the plurality of PSSCHs has an associated HARQ process number. Via the bitmap, the plurality of PSSCHs can be indicated by the associated HARQ process numbers. There are maximum 16 sidelink HARQ process numbers, thus the bitmap may require 16 bits with each bit corresponding to one HARQ process number.

### Option 2-2

Option 2-2 is similar to option 1-3, the second indicator may be a bitmap with each bit in the bitmap corresponding to a group of HARQ processes. Each HARQ process group may include multiple consecutive HARQ process numbers. Each HARQ process group may include the same (or different) number of HARQ process numbers. The plurality of PSSCHs are indicated by the one or more groups of HARQ process numbers with one HARQ process number associated with one of the plurality of PSSCHs. Details for this solution may be referred to option 1-3.

### Option 2-3

Option 2-3 is similar to option 1-5, that is, the second indicator includes a number of bits, which indicate both the total number of consecutive HARQ process numbers and the starting HARQ process number of these consecutive HARQ process numbers. Details for this solution may be referred to option 1-5.

After receiving the SCI format, the second UE determines the PSFCH resource(s) for transmitting the requested sidelink HARQ-ACK feedback for the plurality of PSSCHs.

Specifically, the second UE may determine the PSFCH resource(s) in a similar fashion as option 1-b, option 1-c, and option 1-d, and details may be referred to option 1-b, option 1-c and option 1-d.

In some embodiments, suppose the maximum number that the UE may perform the PSFCH transmissions in one slot is M, and the total number of the PSFCH transmissions requested by the SCI format is N.

In some cases, N may be larger than M, i.e. N>M. In other words, the UE cannot perform the N PSFCH transmissions in one slot, and the following options A and B may be performed:

### Option A

In this option, the N PSFCHs are firstly ordered in ascending order of associated HARQ process numbers, or descending order of the associated HARQ process numbers, or other orders, then the N PSFCHs are bundled to M PSFCHs, with each PSFCH carrying one HARQ-ACK bit. In detail, the N PSFCHs may be divided into M parts. Each part may include K HARQ-ACK information bits and is bundled to one HARQ-ACK bit, wherein K=┌N/M┐. Then the bundled M bits are transmitted by M PSFCHs with each bit on one PSFCH.

Specifically, the UE may perform this option as follows:
1. Order the N PSFCHs in ascending (or descending) order of associated HARQ process numbers;
2. Dividing the PSFCHs into M parts, where each part except the last one or multiple parts includes

$$K = ⌈ \frac{N}{M} ⌉ PSFCHs ,$$

and the last one or multiple parts may include G PSFCHs, where G may be the remainder of N divided by K, or an integer smaller than K.

Each part includes K HARQ-ACK information bits and is bundled to one HARQ-ACK bit then the bundled M bits are transmitted by the M PSFCHs. Therefore, the total N PSFCHs are transmitted in one slot.

For example, suppose M is 4, and N is 11. Then

$$K = ⌈ \frac{11}{4} ⌉ = 3 ,$$

therefore, the N PSFCHs are divided into 4 parts, and each part except the last part includes 3 PSFCHs, and the last part includes 2 PSFCHs. In this case, the first part includes the 1^{st} PSFCH, the 2^{nd} PSFCH, and the 3^{rd} PSFCH, the second part includes the 4^{th} PSFCH, the 5^{th} PSFCH, and the 6^{th} PSFCH, the third part includes the 7^{th} PSFCH, the 8^{th} PSFCH, and the 9^{th} PSFCH, and the fourth part includes the 10^{th} PSFCH and the 11^{th} PSFCH.

The HARQ-ACK bit associated with the 1^{st} PSFCH, the 2^{nd} PSFCH, and the 3^{rd} PSFCH are bundled together, the HARQ-ACK bit associated with the 4^{th} PSFCH, the 5^{th} PSFCH, and the 6^{th} PSFCH are bundled together, the HARQ-ACK bit associated with the 7^{th} PSFCH, the 8^{th} PSFCH, and the 9^{th} PSFCH are bundled together, and the HARQ-ACK bit associated with the 10^{th} PSFCH and the 11^{th} PSFCH are bundled together. After the bundling, there are only four HARQ-ACK bits, which are transmitted by four PSFCHs, respectively. Therefore, the 11 PSFCHs are bundled to four PSFCHs, and the UE may transmit the four PSFCHs in one slot.

For another example, suppose M is 4, and N is 6. Then

$$K = ⌈ \frac{6}{4} ⌉ = 2 ,$$

therefore, the N PSFCHs are divided into 4 parts, and each part except the last two parts includes 2 PSFCHs, and each of the last two parts includes 1 PSFCH. In this case, the first part includes the 1^{st} PSFCH and the 2^{nd} PSFCH, the second part includes the 3^{rd} PSFCH and the 4^{th} PSFCH, the third part includes the 5^{th} PSFCH, and the fourth part includes the 6^{th} PSFCH.

The HARQ-ACK bit associated with the 1^{st} PSFCH and the 2^{nd} PSFCH are bundled together, the HARQ-ACK bit associated with the 3^{rd} PSFCH and the 4^{th} PSFCH are bundled together, the HARQ-ACK bit associated with the 5^{th} PSFCH is not bundled, and the HARQ-ACK bit associated with the 6^{th} PSFCH is not bundled, either. After the bundling, there are only four HARQ-ACK bits, which are transmitted by four PSFCHs, respectively. Therefore, the 6 PSFCHs are bundled to four PSFCHs, and the UE may transmit the four PSFCHs in one slot. Correspondingly, the other UE (i.e. the first UE) receives the four PSFCHs in one slot.

It should be noted that the N PSFCHs may be bundled to S PSFCHs, wherein S is an integer smaller than M, and the S PSFCHs can also be transmitted in one slot. Correspondingly, the other UE (i.e. the first UE) receives the S PSFCHs in one slot.

### Option B

The total PSFCHs are transmitted in multiple consecutive PSFCH slots according to the ascending order of associated HARQ process numbers.

In this option, the N PSFCHs are firstly ordered in ascending order of associated HARQ process numbers, then the N PSFCHs are divided into

$$K = ⌈ \frac{N}{M} ⌉$$

parts. Each part is transmitted in different PSFCH slots. In each PSFCH slot, M PSFCHs can be transmitted. So the total N PSFCHs are transmitted in K consecutive PSFCH slots. Correspondingly, the other UE (i.e. the first UE) receives the total N PSFCHs in K consecutive PSFCH slots.

For example, suppose M is 4, and N is 11. Then

$$K = ⌈ \frac{11}{4} ⌉ = 3 ,$$

therefore, the 11 PSFCHs are divided into 3 parts, the first part includes the 1^{st} PSFCH, the 2^{nd} PSFCH, the 3^{rd} PSFCH, and the 4^{th} PSFCH, the second part includes the 5^{th} PSFCH, the 6^{th} PSFCH, the 7^{th} PSFCH, and 8^{th} PSFCH, the third part includes the 9^{th} PSFCH, the 10^{th} PSFCH and the 11^{th} PSFCH. So the 11 PSFCHs are transmitted in 3 consecutive PSFCH slots.

FIG. 2 illustrates an exemplary sidelink HARQ-ACK feedback transmission according to some embodiments of the present disclosure.

There are 8 slots in FIG. 2, and the PSFCH period is 4 slots. The PSFCHs resources are located at slot 4 and slot 8. In slot 2, the second UE, which may be the Rx UE, receives the SCI format from the first UE, which may be the Tx UE. The SCI format may or may not schedule a PSSCH. The SCI format requests sidelink HARQ-ACK feedback for a plurality of PSSCHs. The plurality of PSSCHs may include PSSCHs transmitted in previous slots with or without received HARQ-ACK feedback.

In slot 4, the second UE transmits the one-shot sidelink HARQ-ACK feedback for the plurality of PSSCHs (and the scheduled PSSCH in the case that a PSSCH is scheduled by the SCI format). That is, the sidelink HARQ-ACK feedback for all the plurality of PSSCHs is transmitted.

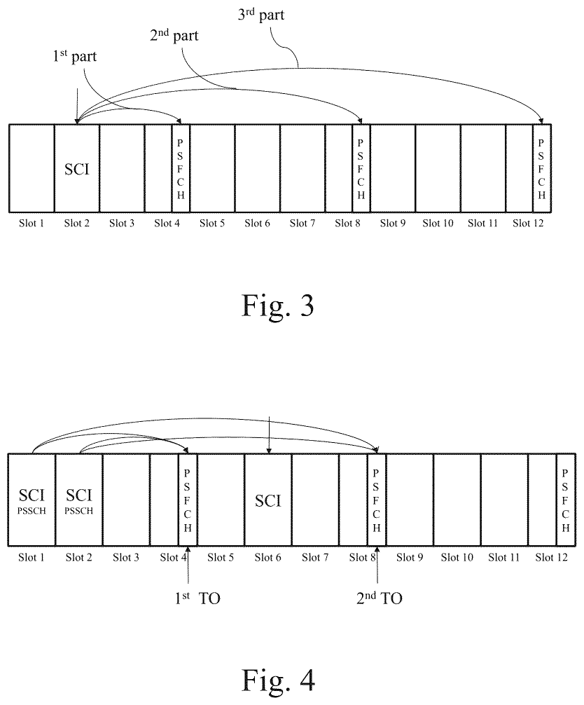

FIG. 3 illustrates an exemplary sidelink HARQ-ACK feedback transmission according to some embodiments of the present disclosure.

There are 12 slots in FIG. 3, and the PSFCH period is 4 slots. The PSFCHs resources are located at slot 4, slot 8 and slot 12. In slot 2, the second UE receives the SCI format from the first UE. The SCI format may or may not schedule a PSSCH. The SCI format requests sidelink HARQ-ACK feedback for a plurality of PSSCHs. The plurality of PSSCHs may include PSSCHs transmitted in previous slots with or without received HARQ-ACK feedback.

Referring to above option B, there are 11 PSFCHs, which are divided into 3 parts. The three consecutive PSFCH slots are slot 4, slot 8, and slot 12 respectively; therefore, the 1^{st} part is transmitted in slot 4, the 2^{nd} part is transmitted in slot 8, and the 3^{rd} part is transmitted in slot 12.

FIG. 4 illustrates an exemplary sidelink HARQ-ACK feedback transmission according to some embodiments of the present disclosure.

There are 12 slots in FIG. 4, the PSFCH period is 4. The second UE receives SCI format in slot 1 and slot 2, and SCI format in slot 1 and SCI format in slot 2 both schedule a PSSCH. The second UE transmits PSFCHs in slot 4 for the PSSCHs in both slot 1 and slot 2, which is the first transmission opportunity (i.e. 1st TO as shown in FIG. 4); however, the first UE fails to receive the PSFCHs in slot 4 due to LBT failure, or link failure, or other issues.

In slot 6, the first UE sends the SCI format for triggering the second UE to retransmit the sidelink HARQ-ACK feedback in slot 8 for the PSSCHs in slot 1 and slot 2. The SCI format may either schedule a PSSCH or not schedule a PSSCH. In the second transmission opportunity (i.e., 2^{nd} TO as shown in FIG. 4) in slot 8, the second UE transmits the sidelink HARQ-ACK feedback for the PSSCHs in slot 1 and slot 2 to the first UE. If in slot 6, the SCI format schedules a PSSCH, the second UE may transmit the sidelink HARQ-ACK feedback for the PSSCHs in slot 1 and slot 2, and the sidelink HARQ-ACK feedback for the scheduled PSSCH to the first UE.

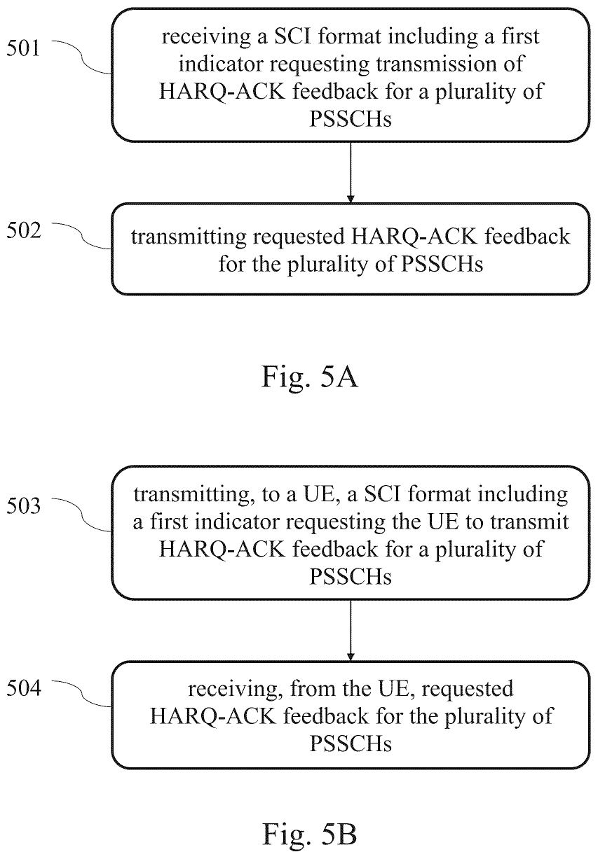

FIG. 5A illustrates a method performed by a UE for wireless communication according to some embodiments of the present disclosure.

In operation 501, the UE (i.e., the second UE, or the Rx UE) may receive a SCI format including a first indicator requesting transmission of HARQ-ACK feedback for a plurality of PSSCHs, wherein each of the plurality of PSSCHs has an associated HARQ process number. For example, in FIG. 4, the second UE receives the SCI format in slot 6, and the SCI format includes the first indicator, requesting transmission of HARQ-ACK feedback for PSSCHs in slot 1 and PSSCH in slot 2. In operation 502, the second UE may transmit the requested HARQ-ACK feedback for the plurality of PSSCHs.

FIG. 5B illustrates a method performed by an apparatus for wireless communication according to some embodiments of the present disclosure.

In operation 503, the apparatus (i.e. the first UE, or the Tx UE), may transmit, to a UE (i.e. the second UE, or the Rx UE), a SCI format including a first indicator requesting the UE (i.e. the second UE) to transmit HARQ-ACK feedback for a plurality of PSSCHs. For example, in FIG. 4, the first UE may transmit the SCI format to the second UE in slot 6, and the SCI format includes the first indicator, requesting transmission of HARQ-ACK feedback for PSSCHs in slot 1 and PSSCH in slot 2. In operation 504, the apparatus (i.e. the first UE) may receive, from the UE (i.e. the second UE), the requested HARQ-ACK feedback for the plurality of PSSCHs.

In some embodiments, the plurality of PSSCHs may include PSSCHs associated with all HARQ processes of the second UE.

In some embodiments, the SCI format further includes a second indicator for indicating the plurality of PSSCHs. For example, the second indicator indicates HARQ process number of each of the plurality of PSSCHs. Referring to FIG. 4, the second indicator may indicate the HARQ process number of the PSSCH in slot 1 and the PSSCH in slot 2. For another example, the second indicator comprises a bitmap with each bit corresponding to a HARQ process number associated with one PSSCH of the plurality of PSSCHs, such as the bitmap described in option 1-2. For still another example, the second indicator comprises a bitmap with each bit corresponding to a respective HARQ process number group, and each respective HARQ process number group includes one or more consecutive HARQ process numbers associated with one or more PSSCHs of the plurality of PSSCHs, such as the bitmap described in option 1-3. For still another example, the second indicator indicates both a number of consecutive HARQ process numbers and the first HARQ process number of the consecutive HARQ process numbers, such as the indicating manner as shown in table 2.

In some embodiments, the SCI format schedules a PSSCH and further indicates an associated HARQ process number of the scheduled PSSCH, and the second indicator indicates a number of consecutive HARQ process numbers associated with the same number of PSSCHs of the plurality of PSSCHs, wherein the first HARQ process number of the number of consecutive HARQ process numbers is the HARQ process number of the scheduled PSSCH, such as the indicating manner as shown in table 1.

In some embodiments, the requested HARQ-ACK feedback for the plurality of PSSCHs is transmitted on a plurality of PSFCHs, and each of the plurality of PSFCHs carrying HARQ-ACK feedback corresponding to one PSSCH of the plurality of PSSCHs. The UE (including both the first UE and the second UE) may further determine a resource index of a first PSFCH for a first PSSCH and the resource indices of the plurality of PSFCHs, wherein the first PSSCH is scheduled by the SCI format and the resource indices of the plurality of PSFCHs contiguously follow the resource index of the first PSFCH. For example, the UE may determine the resource indices as option 1-a. Alternatively, the UE may determine a resource index of each PSFCH of the plurality of PSFCHs based on the HARQ process number associated with the corresponding PSSCH of the plurality of PSSCHs. For example, the UE may determine the resource indices as option 1-b. Alternatively, the UE may determine a resource index of each PSFCH of the plurality of PSFCHs from a dedicated PSFCH resource pool, such as option 1-c.

In some embodiments, the requested HARQ-ACK feedback for the plurality of PSSCHs is transmitted on one PSSCH and a resource of the PSSCH is reserved by the SCI format.

In some embodiments, the requested HARQ-ACK feedback for the plurality of PSSCHs is included in one HARQ-ACK codebook and transmitted on one PSFCH.

In some embodiments: the total number of the plurality of PSFCHs may be larger than a maximum number of transmitted PSFCHs in one slot by the second UE; the second UE may bundle every multiple HARQ-ACK information bits of the requested HARQ-ACK feedback into one HARQ-ACK bit, wherein a bundle size is determined by the total number of the plurality of PSFCHs and the maximum number of transmitted PSFCHs in one slot by the second UE; and the second UE then transmits the maximum number of PSFCHs in one slot with each PSFCH carrying one bundled HARQ-ACK bit. Correspondingly, the first UE may receive the maximum number of PSFCHs in one slot with each PSFCH carrying one bundled HARQ-ACK bit.

Alternatively, the second UE may divide the plurality of PSFCHs into multiple groups with each group comprising a number of PSFCHs not larger than the maximum number of transmitted PSFCHs in one slot by the second UE. The second UE then transmits the HARQ-ACK feedback of the multiple groups in multiple slots with each group transmitted in one slot. Correspondingly, the first UE may receive the HARQ-ACK feedback of the multiple groups in multiple slots with each group transmitted in one slot.

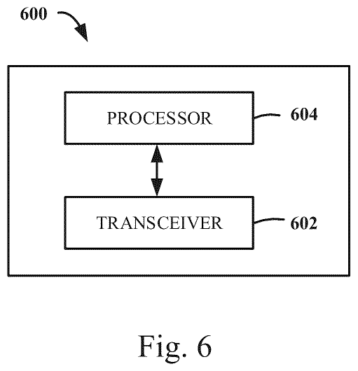

FIG. 6 illustrates a block diagram of an exemplary apparatus 600 according to some embodiments of the present disclosure. As shown in FIG. 6, the apparatus 600 may include at least one processor 604 and at least one transceiver 602 coupled to the processor 604. The apparatus 600 may be a UE or a BS.

Although in this figure, elements such as the at least one transceiver 602 and processor 604 are described in the singular, the plural is contemplated unless a limitation to the singular is explicitly stated. In some embodiments of the present disclosure, the transceiver 602 may be divided into two devices, such as a receiving circuitry and a transmitting circuitry. In some embodiments of the present disclosure, the apparatus 600 may further include an input device, a memory, and/or other components.

In some embodiments of the present disclosure, the apparatus 600 may be a UE. The transceiver 602 and the processor 604 may interact with each other so as to perform the operations with respect to the UE described above, for example, in FIGS. 1-5.

In some embodiments of the present disclosure, the apparatus 600 may be a BS. The transceiver 602 and the processor 604 may interact with each other so as to perform the operations with respect to the BS described above, for example, in FIGS. 1-5.

In some embodiments of the present disclosure, the apparatus 600 may further include at least one non-transitory computer-readable medium. For example, in some embodiments of the present disclosure, the non-transitory computer-readable medium may have stored thereon computer-executable instructions to cause the processor 604 to implement the method with respect to the UE as described above. For example, the computer-executable instructions, when executed, cause the processor 604 interacting with transceiver 602 to perform the operations with respect to the UE described in FIGS. 1-5.

In some embodiments of the present disclosure, the apparatus 600 may further include at least one non-transitory computer-readable medium. For example, in some embodiments of the present disclosure, the non-transitory computer-readable medium may have stored thereon computer-executable instructions to cause the processor 604 to implement the method with respect to the BS as described above. For example, the computer-executable instructions, when executed, cause the processor 604 interacting with transceiver 602 to perform the operations with respect to the BS described in FIGS. 1-5.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, the UE comprising:
a processor;
a memory coupled to the processor; and
a transceiver coupled to the processor, wherein the processor is configured to cause the UE to:
receive, via the transceiver, a sidelink control information (SCI) format including a first indicator requesting transmission of hybrid automatic repeat request acknowledgement (HARQ-ACK) feedback for a plurality of physical sidelink shared channels (PSSCH), wherein each of the plurality of PSSCHs has an associated HARQ process number; and
transmit, via the transceiver, requested HARQ-ACK feedback for the plurality of PSSCHs.

2. The UE of claim 1, wherein the plurality of PSSCHs comprise PSSCHs associated with all HARQ processes of the UE.

3. The UE of claim 1, wherein:
the SCI format further includes a second indicator for indicating the plurality of PSSCHs; and
wherein at least one of:
the second indicator indicates HARQ process number of each of the plurality of PSSCHs;
the second indicator comprises a bitmap with each bit corresponding to a HARQ process number associated with one PSSCH of the plurality of PSSCHs;
the second indicator comprises a bitmap with each bit corresponding to a respective HARQ process number group, and each respective HARQ process number group includes one or more consecutive HARQ process numbers associated with one or more PSSCHs of the plurality of PSSCHs; or
a number of consecutive HARQ process numbers and the first HARQ process number of the consecutive HARQ process numbers are jointly indicated by the second indicator.

4. The UE of claim 3, wherein the SCI format schedules a PSSCH and further indicates an associated HARQ process number of the scheduled PSSCH, and the second indicator indicates a number of consecutive HARQ process numbers associated with a same number of PSSCHs of the plurality of PSSCHs, wherein the first HARQ process number of the number of consecutive HARQ process numbers is the HARQ process number of the scheduled PSSCH.

5. The UE of claim 1, wherein the requested HARQ-ACK feedback for the plurality of PSSCHs is transmitted on a plurality of PSFCHs with each of the plurality of PSFCHs carrying HARQ-ACK feedback corresponding to one PSSCH of the plurality of PSSCHs, and wherein the processor is further configured to cause the UE to:
determine a resource index of a first PSFCH for a first PSSCH and the resource indices of the plurality of PSFCHs, wherein the first PSSCH is scheduled by the SCI format and the resource indices of the plurality of PSFCHs contiguously follow the resource index of the first PSFCH;
determine a resource index of each PSFCH of the plurality of PSFCHs based on the HARQ process number associated with the corresponding PSSCH of the plurality of PSSCHs; or
determine a resource index of each PSFCH of the plurality of PSFCHs from a dedicated PSFCH resource pool.

6. The UE of claim 1, wherein:
the requested HARQ-ACK feedback for the plurality of PSSCHs is transmitted on one PSSCH and a resource of the PSSCH is reserved by the SCI format; or
the requested HARQ-ACK feedback for the plurality of PSSCHs is included in one HARQ-ACK codebook and transmitted on one PSFCH.

7. The UE of claim 5, wherein in response to a total number of the plurality of PSFCHs being larger than a maximum number of transmitted PSFCHs in one slot by the UE, the processor is further configured to cause the UE to:
bundle every multiple HARQ-ACK information bits of the requested HARQ-ACK feedback into one HARQ-ACK bit, wherein a bundle size is determined by the total number of the plurality of PSFCHs and the maximum number of transmitted PSFCHs in one slot by the UE, wherein the transceiver is configured to transmit the maximum number of PSFCHs in one slot with each PSFCH carrying one bundled HARQ-ACK bit; or
divide the plurality of PSFCHs into multiple groups with each group comprising a number of PSFCHs not larger than the maximum number of transmitted PSFCHs in one slot by the UE, and wherein the transceiver is configured to transmit the HARQ-ACK feedback of the multiple groups in multiple slots with each group transmitted in one slot.

8.-14. (canceled)

15. A method performed by a user equipment (UE), the method comprising:
receiving a sidelink control information (SCI) format including a first indicator requesting transmission of hybrid automatic repeat request acknowledgement (HARQ-ACK) feedback for a plurality of physical sidelink shared channels (PSSCH), wherein each of the plurality of PSSCHs has an associated HARQ process number; and
transmitting requested HARQ-ACK feedback for the plurality of PSSCHs.

16. The method of claim 15, wherein the requested HARQ-ACK feedback for the plurality of PSSCHs is transmitted on a plurality of PSFCHs with each of the plurality of PSFCHs carrying HARQ-ACK feedback corresponding to one PSSCH of the plurality of PSSCHs, and wherein the method further comprises at least one of:
determining a resource index of a first PSFCH for a first PSSCH and the resource indices of the plurality of PSFCHs, wherein the first PSSCH is scheduled by the SCI format and the resource indices of the plurality of PSFCHs contiguously follow the resource index of the first PSFCH;
determining a resource index of each PSFCH of the plurality of PSFCHs based on the HARQ process number associated with the corresponding PSSCH of the plurality of PSSCHs; or
determining a resource index of each PSFCH of the plurality of PSFCHs from a dedicated PSFCH resource pool.

17. The method claim 16, wherein in response to a total number of the plurality of PSFCHs being larger than a maximum number of transmitted PSFCHs in one slot by the UE, the method further comprises at least one of:
bundling every multiple HARQ-ACK information bits of the requested HARQ-ACK feedback into one HARQ-ACK bit, wherein a bundle size is determined by the total number of the plurality of PSFCHs and the maximum number of transmitted PSFCHs in one slot by the UE, wherein the transceiver is configured to transmit the maximum number of PSFCHs in one slot with each PSFCH carrying one bundled HARQ-ACK bit; or
dividing the plurality of PSFCHs into multiple groups with each group comprising a number of PSFCHs not larger than the maximum number of transmitted PSFCHs in one slot by the UE, wherein the transceiver is configured to transmit the HARQ-ACK feedback of the multiple groups in multiple slots with each group transmitted in one slot.

18. A processor for wireless communication, configured to:
receive a sidelink control information (SCI) format including a first indicator requesting transmission of hybrid automatic repeat request acknowledgement (HARQ-ACK) feedback for a plurality of physical sidelink shared channels (PSSCH), wherein each of the plurality of PSSCHs has an associated HARQ process number; and
transmit requested HARQ-ACK feedback for the plurality of PSSCHs.

19. The processor of claim 18, wherein the requested HARQ-ACK feedback for the plurality of PSSCHs is transmitted on a plurality of PSFCHs with each of the plurality of PSFCHs carrying HARQ-ACK feedback corresponding to one PSSCH of the plurality of PSSCHs, and wherein the processor is further configured to at least one of:
determine a resource index of a first PSFCH for a first PSSCH and the resource indices of the plurality of PSFCHs, wherein the first PSSCH is scheduled by the SCI format and the resource indices of the plurality of PSFCHs contiguously follow the resource index of the first PSFCH;
determine a resource index of each PSFCH of the plurality of PSFCHs based on the HARQ process number associated with the corresponding PSSCH of the plurality of PSSCHs; or
determine a resource index of each PSFCH of the plurality of PSFCHs from a dedicated PSFCH resource pool.

20. The processor of claim 19, wherein in response to a total number of the plurality of PSFCHs being larger than a maximum number of transmitted PSFCHs in one slot by the UE, the processor is further configured to at least one of:
bundle every multiple HARQ-ACK information bits of the requested HARQ-ACK feedback into one HARQ-ACK bit, wherein a bundle size is determined by the total number of the plurality of PSFCHs and the maximum number of transmitted PSFCHs in one slot by the UE, wherein the transceiver is configured to transmit the maximum number of PSFCHs in one slot with each PSFCH carrying one bundled HARQ-ACK bit; or
divide the plurality of PSFCHs into multiple groups with each group comprising a number of PSFCHs not larger than the maximum number of transmitted PSFCHs in one slot by the UE, wherein the transceiver is configured to transmit the HARQ-ACK feedback of the multiple groups in multiple slots with each group transmitted in one slot.

21. A user equipment (UE) for wireless communication, the UE comprising:
a processor;
a memory coupled to the processor; and
a transceiver coupled to the processor, wherein the processor is configured to cause the UE to:
transmit, to a second user equipment, a sidelink control information (SCI) format including a first indicator requesting the second UE to transmit hybrid automatic repeat request acknowledgement (HARQ-ACK) feedback for a plurality of physical sidelink shared channels (PSSCH), wherein each of the plurality of PSSCHs has an associated HARQ process number; and
receive, from the second UE, requested HARQ-ACK feedback for the plurality of PSSCHs.

22. The UE of claim 21, wherein the plurality of PSSCHs comprise PSSCHs associated with all HARQ processes of the UE.

23. The UE of claim 21, wherein:
the SCI format further includes a second indicator for indicating the plurality of PSSCHs; and
wherein at least one of:
the second indicator indicates HARQ process number of each of the plurality of PSSCHs;
the second indicator comprises a bitmap with each bit corresponding to a HARQ process number associated with one PSSCH of the plurality of PSSCHs;
the second indicator comprises a bitmap with each bit corresponding to a respective HARQ process number group, and each respective HARQ process number group includes one or more consecutive HARQ process numbers associated with one or more PSSCHs of the plurality of PSSCHs; or
a number of consecutive HARQ process numbers and the first HARQ process number of the consecutive HARQ process numbers are jointly indicated by the second indicator.

24. The UE of claim 21, wherein the SCI format schedules a PSSCH and further indicates an associated HARQ process number of the scheduled PSSCH, and the second indicator indicates a number of consecutive HARQ process numbers associated with a same number of PSSCHs of the plurality of PSSCHs, wherein the first HARQ process number of the number of consecutive HARQ process numbers is the HARQ process number of the scheduled PSSCH.

25. The UE of claim 21, wherein the requested HARQ-ACK feedback for the plurality of PSSCHs is received on a plurality of PSFCHs with each of the plurality of PSFCHs carrying HARQ-ACK feedback corresponding to one PSSCH of the plurality of PSSCHs, and wherein the processor is further configured to cause the UE to at least one of:
determine a resource index of a first PSFCH for a first PSSCH and the resource indices of the plurality of PSFCHs, wherein the first PSSCH is scheduled by the SCI format and the resource indices of the plurality of PSFCHs contiguously follow the resource index of the first PSFCH;
determine a resource index of each PSFCH of the plurality of PSFCHs based on the HARQ process number associated with the corresponding PSSCH of the plurality of PSSCHs; or
determine a resource index of each PSFCH of the plurality of PSFCHs from a dedicated PSFCH resource pool.

26. The UE of claim 25, wherein in response to a total number of the plurality of PSFCHs being larger than a maximum number of transmitted PSFCHs in one slot by the UE, wherein the processor is configured to cause the UE to at least one of:
receive, via the transceiver, the maximum number of PSFCHs in one slot with each PSFCH carrying one bundled HARQ-ACK bit; or
receive, via the transceiver, the HARQ-ACK feedback of the multiple groups in multiple slots with each group transmitted in one slot.

27. The base station of claim 21, wherein:
the requested HARQ-ACK feedback for the plurality of PSSCHs is received on one PSSCH and a resource of the PSSCH is reserved by the SCI format; or
the requested HARQ-ACK feedback for the plurality of PSSCHs is included in one HARQ-ACK codebook and received on one PSFCH.
